(19) United States
(12) Patent Application Publication
(10) Pub. No.: US 2017/0032753 A1
(43) Pub. Date: Feb. 2, 2017

(54) POWER SUPPLY, DISPLAY DEVICE WITH THE SAME, AND DRIVING METHOD OF POWER SUPPLY

(71) Applicant: Samsung Display Co., Ltd., Yongin-si (KR)

(72) Inventors: Yun Mi Kim, Yongin-si (KR); Ki Hyun Pyun, Yongin-si (KR); Jang Hoon Kwak, Yongin-si (KR); Jong Young Yun, Yongin-si (KR); Eui Myeong Cho, Yongin-si (KR)

(21) Appl. No.: 15/170,783

(22) Filed: Jun. 1, 2016

(30) Foreign Application Priority Data
Jul. 31, 2015 (KR) 10-2015-0109004

(51) Int. Cl. G09G 3/36; G05F 1/46; G05F 1/575

(52) U.S. Cl. CPC G09G 3/3648; G05F 1/575; G05F 1/462; G09G 2330/021

(57) ABSTRACT

A power supply of the present disclosure includes: a power generator that generates a first driving voltage to be supplied to a timing controller; and a voltage compensator that performs feedback of the first driving voltage and generates a feedback voltage according to a voltage difference between the first driving voltage and a first reference voltage supplied from the power generator. In this structure, the power generator generates a second driving voltage by boosting or dropping the first driving voltage to correspond to the feedback voltage, and may supply the second driving voltage to the timing controller.

### CROSS-REFERENCE TO RELATED APPLICATION

This application claims priority to and the benefit of Korean Patent Application No. 10-2015-0109004, filed on Jul. 31, 2015, in the Korean Intellectual Property Office, the entire content of which is incorporated herein by reference in its entirety.

### BACKGROUND

1. Field

The present disclosure relates to a power supply, a display device with the same, and a driving method of the power supply.

2. Description of the Related Art

Currently, widely known display devices include organic light emitting display devices, liquid crystal display devices, plasma display devices, etc.

A display device includes a display panel with pixels emitting light, a timing controller that generates control signals to be supplied to the pixels, and a power supply that generates an electric power for driving the display device.

The timing controller may be supplied with the power by the power supply. In this case, the power supply needs to supply the power with an appropriate voltage to the timing controller. However, a voltage drop may occur at a wire between the timing controller and the power supply while the power is supplied to the timing controller.

When supplied with voltage lower than the appropriate voltage, the timing controller may not perform a required operation. For example, the timing controller should generate the control signals to be supplied to a data driver and a scan driver so that the pixels can emit light with a set or predetermined luminance, but if the power lower than the appropriate voltage is supplied to the timing controller, the unstable control signals may be generated.

### SUMMARY

Aspects of embodiments of the present invention are directed toward a power supply capable of compensating for a voltage drop generated between a timing controller and the power supply, a display device with the power supply, and a driving method of the power supply.

A power supply according to an exemplary embodiment of the present disclosure may include: a power generator that generates a first driving voltage to be supplied to a timing controller; and a voltage compensator that performs feedback of the first driving voltage and generates a feedback voltage according to a voltage difference between the first driving voltage and a first reference voltage supplied from the power generator. In this structure, the power generator may generate a second driving voltage by boosting or dropping the first driving voltage to correspond to the feedback voltage, and may supply the second driving voltage to the timing controller.

In this embodiment, the voltage compensator may include: a comparator that calculates the voltage difference between the first driving voltage and the first reference voltage and generates a comparison signal depending on a calculation result; an analog to digital converter that generates a digital signal based on the comparison signal; a data register that stores the digital signal therein; a digital to analog converter that generates an analog signal based on the digital signal; and a feedback voltage generator that generates the feedback voltage according to the level of the analog signal.

In this embodiment, the feedback voltage generator may include a voltage divider that generates the feedback voltage by dividing a second reference voltage supplied from the power generator.

In this embodiment, the voltage divider may include a variable resistor whose resistance varies according to the level of the analog signal when the analog signal is supplied.

In this embodiment, the voltage divider may include a transistor of which a gate electrode is connected to an input terminal of the voltage divider, a first electrode is connected to an output terminal of the voltage divider and from which the feedback voltage is outputted, and a second electrode is connected to the ground, and wherein a voltage level of the first electrode of the transistor varies according to the level of the analog signal.

In this embodiment, the power generator may compare the feedback voltage and a third reference voltage and may generate the second driving voltage by boosting the first driving voltage when the feedback voltage is lower than the third reference voltage and by dropping the first driving voltage when the feedback voltage is higher than the third reference voltage.

In this embodiment, the voltage difference between the first driving voltage and the first reference voltage may be a dropped voltage due to a resistive component existing between the power generator and the timing controller.

In this embodiment, a voltage of the analog signal may be higher than the voltage difference between the first driving voltage and the first reference voltage.

A display device according to another exemplary embodiment of the present disclosure may include: a display panel including a plurality of pixels connected to a plurality of scan lines and a plurality of data lines; a timing controller that generates control signals for controlling light emission of the pixels; and a power supply that is disposed outside the display panel and supplies a power to the pixels and the timing controller via first wires. In this structure, the power supply may include: a power generator for generating a first driving voltage to be supplied to the timing controller; and a voltage compensator that performs feedback of the first driving voltage and generates a feedback voltage according to a voltage difference between the first driving voltage and a first reference voltage supplied from the power generator. This power generator may generate a second driving voltage by boosting or dropping the first driving voltage to correspond to the feedback voltage, and may supply the second driving voltage to the timing controller.

In this embodiment, the voltage compensator may include: a comparator that calculates the voltage difference between the first driving voltage and the first reference voltage and generates a comparison signal depending on a calculation result; an analog to digital converter that generates a digital signal based on the comparison signal; a data register that stores the digital signal therein; a digital to analog converter that generates an analog signal based on the digital signal; and a feedback voltage generator that generates the feedback voltage according to the level of the analog signal.

In this embodiment, the feedback voltage generator may include a voltage divider that generates the feedback voltage by dividing a second reference voltage supplied from the power generator.

In this embodiment, the voltage divider may include a variable resistor whose resistance varies according to the level of the analog signal when the analog signal is supplied.

In this embodiment, the voltage divider may include a transistor of which a gate electrode is connected to an input terminal of the voltage divider, a first electrode is connected to an output terminal of the voltage divider and from which the feedback voltage is outputted, and a second electrode is connected to the ground, and wherein a voltage level of the first electrode of the transistor varies according to the level of the analog signal.

In this embodiment, the power generator may compare the feedback voltage and a third reference voltage, and may generate the second driving voltage by boosting the first driving voltage when the feedback voltage is lower than the third reference voltage and by dropping the first driving voltage when the feedback voltage is higher than the third reference voltage.

A driving method of a power supply unit according to still another exemplary embodiment of the present disclosure may include: an act of generating a first driving voltage to be supplied to a timing controller and supplying the first driving voltage to the timing controller; an act of performing feedback of the first driving voltage that detects a voltage drop due to a resistive component, while supplied to the timing controller; an act of comparing the first driving voltage after the feedback and a first reference voltage and generating a feedback voltage corresponding to a voltage difference between the first driving voltage and the first reference voltage; an act of generating a second driving voltage by changing a voltage level of the first driving voltage based on the feedback voltage; and an act of supplying the second driving voltage to the timing controller.

In this embodiment, the act of generating the second driving voltage may be executed by boosting or dropping the first driving voltage as much as a preset voltage according to the level of the feedback voltage.

According to the embodiments of the present disclosure, the voltage drop generated between the timing controller and the power supply can be compensated by returning the first driving voltage supplied to the timing controller to the power supply and then generating the second driving voltage resulted from compensating the first driving voltage based on the feedback voltage. As a result, the timing controller receives the driving power with the appropriate voltage, thereby performing a normal operation.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete and will fully convey the scope of the example embodiments to those skilled in the art. In the drawing figures, dimensions may be exaggerated for clarity of illustration. It will be understood that when an element is referred to as being “between” two elements, it can be the only element between the two elements, or one or more intervening elements may also be present therebetween. Like reference numerals refer to like elements throughout.

FIG. 1 is a schematic block diagram of a display device according to an exemplary embodiment of the present disclosure.

FIG. 2 is a block diagram of a power supply and a timing controller shown in FIG. 1 and according to an exemplary embodiment of the present disclosure.

FIG. 3 is a schematic block diagram for illustrating a voltage compensator shown in FIG. 2 and according to an exemplary embodiment of the present disclosure.

FIG. 4 is a schematic block diagram for illustrating a method for generating a feedback voltage according to an exemplary embodiment of the present disclosure.

FIG. 5 is a flow chart for illustrating a driving method of the power supply according to an exemplary embodiment of the present disclosure.

### DETAILED DESCRIPTION

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

It will be understood that when an element or layer is referred to as being “on,” “connected to,” or “coupled to” another element or layer, it can be directly on, connected to, or coupled to the other element or layer, or one or more intervening elements or layers may be present. In addition, other expressions that describe relationships among constituent elements such as, “between,” “just between,” or “adjacent to” and “directly adjacent to” should be understood in a like manner.

Terms used in the present specification are used only to describe specific exemplary embodiments, and are not intended to limit the present invention. Singular forms are to include plural forms unless the context clearly indicates otherwise. It will be further understood that terms “comprises” or “have” used in the present specification specify the presence of stated features, numerals, acts, operations, components, parts, or a combination thereof, but do not preclude the presence or addition of one or more other features, numerals, acts, operations, components, parts, or a combination thereof.

The present invention will be described more fully hereinafter with reference to the accompanying drawings, in which exemplary embodiments of the invention are shown.

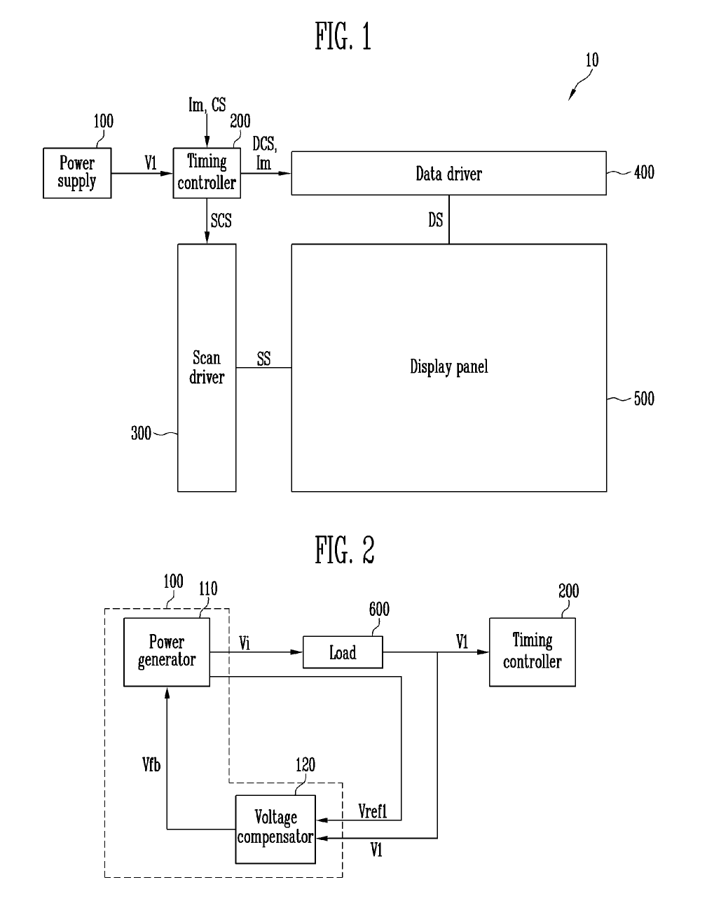

FIG. 1 is a schematic block diagram of a display device according to an exemplary embodiment of the present disclosure.

Referring to FIG. 1, the display device 10 according to the exemplary embodiment of the present disclosure includes a timing controller 200, a scan driver 300, a data driver 400, a display panel 500, and a power supply 100.

The timing controller 200 may generate a data driving control signal DSC and a scan driving control signal SCS in response to externally supplied synchronization signals, such as a vertical synchronization signal, a horizontal synchronization signal, a data enable signal, and/or image data.

The timing controller 200 may supply the data driving control signal DSC to the data driver 400, and the scan driving control signal SCS to the scan driver 300. The timing controller 200 may supply the externally supplied image data Im to the data driver 400.

The scan driver 300 may sequentially supply scan signals SS to scan lines in response to the scan driving control signal SCS supplied from the timing controller 200.

The data driver 400 may generate data signals DS using the image data Im and the data driving control signal DCS supplied from the timing controller 200, and may supply the generated data signals DS to data lines.

The data driver 400 may be directly formed on the display panel 500, or mounted on the display panel 500 in the form of an integrated circuit (IC).

The display panel 500 may include pixels for displaying a set or predetermined image, and may display the image according to the control of the timing controller 200.

In more detail, each pixel may receive the data signal DS from the corresponding data line when the scan signal SS is supplied to the scan line. The pixel to which the data signal is supplied may emit light with luminance corresponding to the data signal DS.

The display panel 500 may be implemented with or as an organic light emitting display panel, a liquid crystal display panel, or a plasma display panel. However, the present disclosure is not necessarily limited thereto.

The power supply 100 is disposed outside the display panel 500 to generate a driving power to be supplied to the pixels of the display panel 500.

For example, the power supply 100 may receive a set or predetermined voltage from a power source, such as a battery or the like. The power supply 100 may convert the received voltage to a voltage required for driving the pixels, and then may supply it to the pixels.

Also, the power supply 100 may supply the driving power (e.g., driving voltage V1) to the timing controller 200.

In this case, when a voltage level of the driving power supplied to the timing controller 200 from the power supply 100 is lower or higher than a set or predetermined value, the control signal may be generated with an unstable voltage level.

For example, when the power supply 100 supplies the driving power to the timing controller 200, a voltage drop may occur in the driving power due to resistive components (for example, resistors of electric wires, etc.) electrically connected between the power supply 100 and the timing controller 200.

To solve this problem, the power supply 100 according to the exemplary embodiment of the present disclosure generates a feedback power through feedback of the driving power supplied to the timing controller 200, and changes the driving power to correspond to the feedback power, thereby compensating the voltage drop.

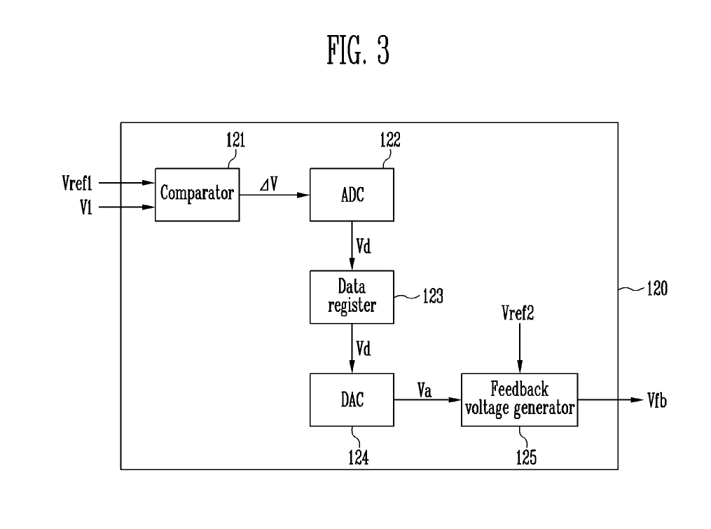

FIG. 2 is a block diagram of the power supply 100 and the timing controller 200 according to an exemplary embodiment of the present disclosure.

Referring to FIG. 2, the power supply 100 according to the exemplary embodiment of the present disclosure generates a driving power and supplies it to the timing controller 200. In addition, the power supply 100 generates a compensated driving power through feedback of the driving power supplied to the timing controller 200.

The power supply 100 may include a power generator 110 and a voltage compensator 120.

The power generator 110 may generate an initial driving voltage Vi to be supplied to the timing controller 200. The initial driving voltage Vi may be supplied to the timing controller 200 via an electric wire.

In this case, a voltage drop may occur in the initial driving voltage Vi due to a load 600 which is between the power supply 100 and the timing controller 200. The load 600 may include a resistor of an electric wire, a bead resistor, etc.

As a result, the power supply 100 may supply a first driving voltage V1 that is lower than initial driving voltage Vi to the timing controller 200 due to the voltage drop.

The voltage compensator 120 according to the exemplary embodiment of the present disclosure may perform the feedback of the first driving voltage V1 to compensate the voltage drop generated by the load 600. In this case, the voltage compensator 120 may receive the first driving voltage V1 via the wire electrically connected to an input terminal of the timing controller 200 to which the first driving voltage V1 is applied.

In addition, the voltage compensator 120 may receive a first reference voltage Vref1 from the power generator 110, and may compare a voltage level of the first driving voltage V1 and that of the first reference voltage Vref1.

The voltage compensator 120 may generate a feedback voltage Vfb for compensating the first driving voltage V1 depending on a comparison result of the first driving voltage V1 and the first reference voltage Vref1, and may supply it to the power generator 110.

The power generator 110 may generate a second driving voltage V2 by boosting or dropping the first driving voltage V1 to correspond to the feedback voltage Vfb.

The power generator 110 compares a voltage level of a third reference voltage Vref3 which is previously set and that of the feedback voltage Vfb, and may determine the level of dropped voltage at the load 600. The power supply 100 may generate the second driving voltage V2 by boosting the first driving voltage V1 as much as the dropped voltage.

If the feedback voltage Vfb is higher than the third reference voltage Vref3, the power generator 110 generates the second driving voltage V2 by dropping the first driving voltage V1.

The power generator 110 may supply the second driving voltage V2 generated to correspond to the feedback voltage Vfb to the timing controller 200.

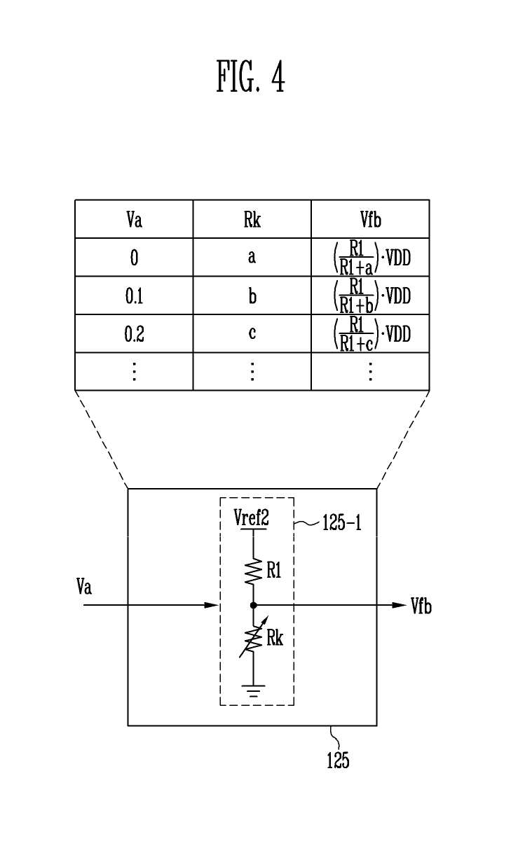

FIG. 3 is a schematic block diagram for illustrating the voltage compensator 120 shown in FIG. 2.

Referring to FIG. 3, the voltage compensator 120 may include a comparator 121, an analog to digital converter (ADC) 122, a data register 123, a digital to analog converter (DAC) 124, and a feedback voltage generator 125.

The comparator 121 may calculate a voltage difference between the first driving voltage V1 and the first reference voltage Vref1, and may generate a comparison signal ΔV depending on a calculation result.

For example, if the first driving voltage V1 is 1.0V and the first reference voltage Vref1 is 1.2V, the comparator 121 may generate the comparison signal ΔV for 0.2V that is a difference of the first driving voltage V1 and the first reference voltage Vref1. In other words, the comparator 121 generates the comparison signal ΔV corresponding to the dropped voltage, 0.2V due to the load 600.

In more detail, If the first driving voltage V1 is higher than or same as the first reference voltage Vref1, the comparator 121 compares the voltage level of the first driving voltage V1 and that of the first reference voltage Vref1, and may generate the comparison signal ΔV including information in which the first driving voltage V1 is higher than or same as the first reference voltage Vref1.

The analog to digital converter 122 receives the comparison signal ΔV from the comparator 121, and may generate a digital signal Vd based on the comparison signal ΔV.

The data register 123 stores the digital signal Vd generated by the analog to digital converter 122, and then may return it to the analog to digital converter 122 to convert it to an analog signal Va.

The digital to analog converter 124 may generate the analog signal Va capable of being recognized by the feedback voltage generator 125 based on the digital signal Vd. This analog signal Va may have a voltage higher than a voltage difference between the first driving voltage V1 and the first reference voltage Vref1.

The voltage difference between the first driving voltage V1 and the first reference voltage Vref1 may be too low to be recognized by the feedback voltage generator 125. Accordingly, the digital to analog converter 124 amplifies it to become higher than the voltage of the comparison signal ΔV.

The feedback voltage generator 125 may generate the feedback voltage Vfb using the analog signal Va supplied from the digital to analog converter 124.

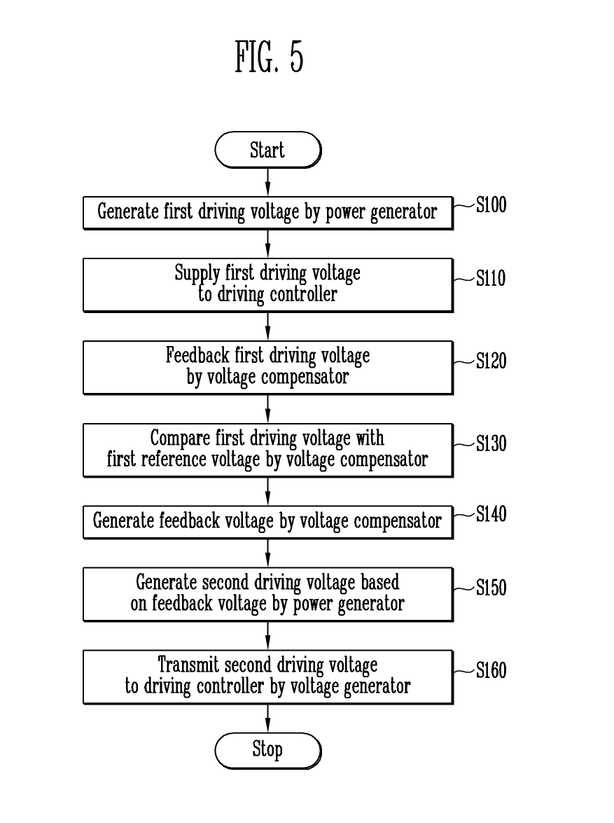

For example, the feedback voltage generator 125 may receive a second reference voltage Vref2 from the power generator 110, and may generate the feedback voltage Vfb by dividing the second reference voltage Vref2 according to the analog signal Va. A method for generating the feedback voltage will be described in more detail with reference to FIG. 4.

The feedback voltage generator 125 may be supplied with the second reference voltage Vref2 from an additional power source provided outside the power supply 100.

The feedback voltage generator 125 may supply the feedback voltage Vfb to the power supply 100.

FIG. 4 is a schematic block diagram for illustrating a method for generating the feedback voltage according to an exemplary embodiment of the present disclosure.

Referring to FIG. 4, the feedback voltage generator 125 may include a voltage divider 125-1 for generating the feedback voltage Vfb by dividing the second reference voltage Vref2.

The voltage divider 125-1 may include an equivalent resistor R1 and a variable resistor whose electrical resistance varies depending on the voltage of the analog signal Va.

For ease of description, it is assumed that VDD is the level of the second reference voltage Vref2, R1 is the equivalent resistor disposed between the input terminal of the second reference voltage Vref2 and the variable resistor, and the feedback voltage Vfb can be determined according to the following equation.

$$Vfb = ( \frac{R 1}{R 1 + Rk} ) \cdot VDD$$

If the first driving voltage V1 is same as the first reference voltage Vref1, the analog signal Va generated by the digital to analog converter 124 may be set to have 0V. In this case, resistance of the variable resistor Rk may be set as “a” based on preset standards, and the feedback voltage generator 125 may generate the feedback voltage Vfb of

$$( \frac{R 1}{R 1 + a} ) \cdot VDD$$

according to the variable resistor Rk whose resistance is “a”.

As another example, if the analog signal Va is 0.1V, resistance of the variable resistor Rk may be set as “b” based on the preset standards, and the feedback voltage generator 125 may generate the feedback voltage Vfb of

$$( \frac{R 1}{R 1 + b} ) \cdot VDD$$

according to the variable resistor Rk whose resistance is “b”.

In another embodiment, the voltage divider 125-1 may include or be a transistor of which a gate electrode is connected to an input terminal of the voltage divider 125-1, a first electrode is connected to an output terminal of the voltage divider 125-1 and from which the feedback voltage is outputted, and a second electrode is connected to the ground.

In this case, the transistor may generate the feedback voltage Vfb by changing the voltage level of the first electrode according to the level of the analog signal Va.

Referring back to FIG. 2, the feedback voltage generator 125 may supply the feedback voltage Vfb generated by the feedback voltage generator 125 to the power generator 110.

The power generator 110 may generate the second driving voltage resulted from compensating the voltage drop at the load 600 using the feedback voltage Vfb and the third reference voltage Vref3.

In this case, the third reference voltage Vref3 may be a reference voltage preset by the power generator 110, or may be an externally supplied reference voltage.

In more detail, the power generator 110 first compares the feedback voltage Vfb and the third reference voltage Vref3, and then boosts the first driving voltage V1 as much as a preset voltage when the feedback voltage Vfb is lower than the third reference voltage Vref3, or drops the first driving voltage V1 as much as the preset voltage when the feedback voltage Vfb is higher than the third reference voltage Vref3, thereby generating the second driving voltage V2.

Regardless of the voltage drop generated between the power generator 110 and the timing controller 200, the power generator (e.g., voltage generator) 110 can supply the power with a desired voltage level by generating the second driving voltage to the timing controller 200.

That is, even if the second driving voltage supplied from the voltage generator 110 is dropped by the load 600, the timing controller 200 may receive the power of an appropriate voltage level, thereby performing a normal operation.

FIG. 5 is a flow chart for illustrating a driving method of the power supply 100 according to an exemplary embodiment of the present disclosure.

Referring to FIG. 2 and FIG. 5, the power generator 110 generates the first driving voltage V1 to be supplied to the timing controller 200 at act S100, and then supplies it to the timing controller 200 at act S110.

The voltage compensator 120 performs feedback of the driving voltage V1 supplied to the timing controller 200 at act S120. Then, the voltage compensator 120 compares the first driving voltage V1 and the first reference voltage Vref1 at act S130, and generates the feedback voltage Vfb depending on a comparison result at act S140.

Then, at act S150, the power generator 110 generates the second driving voltage V2 to compensate the voltage drop generated between the power supply 100 and the timing controller 200, and supplies the second driving voltage V2 to the timing controller 200 at act S160.

In the drawings, the relative sizes of elements, layers, and regions may be exaggerated for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Example embodiments have been disclosed herein and although specific terms are employed, they are used and are to be interpreted in a generic and descriptive sense only and not for purpose of limitation. In some instances, as would be apparent to one of ordinary skill in the art as of the filing of the present application, features, characteristics and/or elements described in connection with a particular embodiment may be used singly or in combination with features, characteristics and/or elements described in connection with other embodiments unless otherwise specifically indicated. Accordingly, it will be understood by those of skill in the art that various changes in form and details may be made without departing from the spirit and scope of the present invention as set forth in the following claims, and equivalents thereof.

What is claimed is:

1. A power supply comprising:
a power generator configured to generate a first driving voltage to be supplied to a timing controller; and
a voltage compensator configured to perform feedback of the first driving voltage and to generate a feedback voltage according to a voltage difference between the first driving voltage and a first reference voltage supplied from the power generator,
wherein the power generator is configured to generate a second driving voltage by boosting or dropping the first driving voltage to correspond to the feedback voltage and to supply the second driving voltage to the timing controller.

2. The power supply of claim 1, wherein the voltage compensator comprises:
a comparator configured to calculate the voltage difference between the first driving voltage and the first reference voltage and to generate a comparison signal depending on a calculation result;
an analog to digital converter configured to generate a digital signal based on the comparison signal;
a data register configured to store the digital signal;
a digital to analog converter configured to generate an analog signal based on the digital signal; and
a feedback voltage generator configured to generate the feedback voltage according to the level of the analog signal.

3. The power supply of claim 2, wherein the feedback voltage generator comprises a voltage divider configured to generate the feedback voltage by dividing a second reference voltage supplied from the power generator.

4. The power supply of claim 3, wherein the voltage divider comprises a variable resistor whose resistance varies according to the level of the analog signal when the analog signal is supplied.

5. The power supply of claim 3, wherein the voltage divider comprises a transistor of which a gate electrode is connected to an input terminal of the voltage divider, a first electrode is connected to an output terminal of the voltage divider and from which the feedback voltage is outputted, and a second electrode is connected to the ground, and wherein the transistor is configured to vary a voltage level of the first electrode according to the level of the analog signal.

6. The power supply of claim 1, wherein the power generator is configured to compare the feedback voltage and a third reference voltage and to generate the second driving voltage by boosting the first driving voltage when the feedback voltage is lower than the third reference voltage and by dropping the first driving voltage when the feedback voltage is higher than the third reference voltage.

7. The power supply of claim 2, wherein the voltage difference between the first driving voltage and the first reference voltage is a dropped voltage due to a resistive component existing between the power generator and the timing controller.

8. The power supply of claim 2, wherein a voltage of the analog signal is higher than the voltage difference between the first driving voltage and the first reference voltage.

9. A display device comprising:
a display panel comprising a plurality of pixels connected to a plurality of scan lines and a plurality of data lines;
a timing controller configured to generate control signals for controlling light emission of the pixels; and
a power supply disposed outside the display panel and configured to supply a power to the pixels and the timing controller via first wires,
wherein the power supply comprises: a power generator configured to generate a first driving voltage to be supplied to the timing controller; and a voltage compensator configured to perform feedback of the first driving voltage and to generate a feedback voltage according to a voltage difference between the first driving voltage and a first reference voltage supplied from the power generator, and
wherein the power generator is configured to generate a second driving voltage by boosting or dropping the first driving voltage to correspond to the feedback voltage and to supply the second driving voltage to the timing controller.

10. The display device of claim 9, wherein the voltage compensator comprises:
a comparator configured to calculate the voltage difference between the first driving voltage and the first reference voltage and to generate a comparison signal depending on a calculation result;
an analog to digital converter configured to generate a digital signal based on the comparison signal;
a data register configured to store the digital signal;
a digital to analog converter configured to generate an analog signal based on the digital signal; and
a feedback voltage generator configured to generate the feedback voltage according to the level of the analog signal.

11. The display device of claim 10, wherein the feedback voltage generator comprises a voltage divider configured to generate the feedback voltage by dividing a second reference voltage supplied from the power generator.

12. The display device of claim 11, wherein the voltage divider comprises a variable resistor whose resistance varies according to the level of the analog signal when the analog signal is supplied.

13. The display device of claim 11, wherein the voltage divider comprises a transistor of which a gate electrode is connected to an input terminal of the voltage divider, a first electrode is connected to an output terminal of the voltage divider and from which the feedback voltage is outputted, and a second electrode is connected to the ground, and wherein a voltage level of the first electrode of the transistor is configured to vary according to the magnitude of the analog signal.

14. The display device of claim 9, wherein the power generator is configured to compare the feedback voltage and a third reference voltage and to generate the second driving voltage by boosting the first driving voltage when the feedback voltage is lower than the third reference voltage and by dropping the first driving voltage when the feedback voltage is higher than the third reference voltage.

15. A driving method of a power supply unit, the driving method comprising:
generating a first driving voltage to be supplied to a timing controller and supplying the first driving voltage to the timing controller;
performing feedback of the first driving voltage that detects a voltage drop due to a resistive component, while supplied to the timing controller;
comparing the first driving voltage after the feedback and a first reference voltage and generating a feedback voltage corresponding to a voltage difference between the first driving voltage and the first reference voltage;
generating a second driving voltage by changing a voltage level of the first driving voltage based on the feedback voltage; and
supplying the second driving voltage to the timing controller.

16. The driving method of claim 15, wherein the generating of the second driving voltage is executed by boosting or dropping the first driving voltage as much as a preset voltage according to the level of the feedback voltage.
